(19) United States
(12) Patent Application Publication
(10) Pub. No.: US 2020/0175453 A1
(43) Pub. Date: Jun. 4, 2020

(54) TECHNIQUES FOR MEASURING A COMPANY'S TALENT BRAND STRENGTH

(71) Applicant: Microsoft Technology Licensing, LLC, Redmond, WA (US)

(72) Inventors: Sebastian Predescu, San Francisco, CA (US); Blake Henderson, San Francisco, CA (US); Michael Booz, San Francisco, CA (US); Juanyan Li, Milpitas, CA (US); Joseph Kelly, San Francisco, CA (US); Michael Jennings, San Francisco, CA (US)

(21) Appl. No.: 16/206,704

(22) Filed: Nov. 30, 2018

(51) Int. Cl. G06Q 10/06; G06Q 10/10

(52) U.S. Cl. CPC G06Q 10/06393; G06Q 10/1053

(57) ABSTRACT

Described herein are techniques for generating for each company in a set of companies a rating score that represents the desirability of employment with the company. The rating score for each company is derived by analyzing the member profiles of members of an online system to identify employee transitions between companies over certain time periods. At the beginning of a first time period, each company is assigned a baseline score. Each transition represents an employee departure (loss), for one company, and an employee hire (win), for the other company. With each transition by an employee to/from a company, the rating score of the impacted companies are adjusted—increased for a win, decreased for a loss—in some proportion that is relative to the current rating scores of the impacted companies. Accordingly, company A hires an employee from Company B, the rating scores of companies A and. B will impact the level of the adjustment that is made to their respective rating scores as a result of the transition.

### TECHNICAL FIELD

The present application generally relates to computer technology for addressing technical challenges in quantifying the desirability of employment with a company, by employees and prospective employees. More specifically, the present application relates to an algorithm that takes as input information relating to employment decisions made by employees of companies as indicated in member profiles of an online system, and then provides as output a metric indicating how attractive and/or desirable the company is relative to some set of peer companies.

### BACKGROUND

Companies spend a lot of time and money on activities relating to marketing their brand for the purpose of attracting, recruiting and hiring talented professionals. This type of marketing is a form of storytelling, where the objective is to communicate the company values and culture to a target audience that includes both current employees as well as prospective employees. In the digital age, a significant part of this storytelling is accomplished with online systems, using content publishing tools and social media platforms. As an example, employment websites and online social networking systems provide brand management personnel with tools for creating company profiles or pages (e.g., web pages), and tools for publishing articles and other content, all with the aim of influencing how current and prospective employees think about their respective brands and companies. Measuring the effectiveness and impact of a company's efforts to influence how its brand is perceived in the marketplace for talent is an extremely challenging task.

### BRIEF DESCRIPTION OF THE DRAWINGS

Embodiments of the present invention are illustrated by way of example and not limitation in the figures of the accompanying drawings, in which:

FIG. 1 is a user interface diagram illustrating an example of a member profile showing an employment history of a member of an online system, consistent with embodiments of the present invention;

FIG. 2 is a table illustrating the tabulation of employee transitions between companies, consistent with embodiments of the invention;

FIG. 3 is a chart referred to herein as a talent flow chart, which is based on the data included in the table of FIG. 3, and illustrating for one company the net flow of talent to and from other companies, consistent with embodiments of the present invention;

FIG. 4 is a block diagram illustrating functional components of a system for quantifying the desirability of employment with a company, relative to a set of peer companies, consistent with embodiments of the present invention;

FIG. 5 is a flow diagram showing the method operations involved in a method for deriving the talent brand rating scores for a set of companies, consistent with some embodiments of the present invention;

FIG. 6 is a line chart illustrating an example of a company's talent brand rating score plotted over time, and shown in relation to the talent brand rating scores of a set of peer companies, consistent with embodiments of the invention;

FIG. 7 is a user interface diagram showing an example of a chart that has companies mapped to quadrants based on their talent brand rating scores, consistent with embodiments of the invention; and

FIG. 8 is a system diagram illustrating an example of a computing device with which, embodiments of the present invention might be implemented.

### DETAILED DESCRIPTION

Described herein are methods and systems for objectively quantifying the desirability, by employees and prospective employees, of employment with a company, based on real-world, observed outcomes. Specifically, the present disclosure describes techniques for generating a talent brand rating score for each company having a presence in an online system, such as a social networking system, using employment decision information obtained from member profiles of the online system and indicating the movement or transition of employees between companies. In the following description, for purposes of explanation, numerous specific details and features are set forth in order to provide a thorough understanding of the various aspects of different embodiments of the present invention. It will be evident, however, to one skilled in the art, that the present invention may be practiced with varying combinations of the many details and features.

In an effort to both retain current employees and also attract new employees, companies spend a significant amount of time and resources building and communicating company values and culture in an effort to make others aware of what is commonly referred to as the company's talent brand. The concept of a talent brand can be thought of as the highly social, public version of an employer's brand that incorporates what people—particularly current and prospective employees—think, feel, and share about the company as a place of employment. The more desirable employment with a particular company is, the stronger the talent brand is for that company. Unfortunately, measuring a company's talent brand strength is challenging.

Historically, one way that talent brand strength has been measured is through surveys. For instance, survey questions have been used to capture the sentiment of various categories of people, such as current employees, new hires, job applicants, prospective employees, and so forth. However, surveys have a number of inherent problems. For example, surveys that use rating scales (e.g., provide a rating between one and ten) will often trigger inconsistent results based on differences in people's understanding of the scale, or simply through error or mistake. Additionally, some people are simply hesitant to spend the time to complete surveys.

More recently, more objective data has been used to measure talent brand strength. One example is the number of job applicants that apply for an available job opening, such as might he presented via an online job hosting service. If the number of job applicants per job opening is high, this can be inferred as a signal of talent brand strength. If recruiters are emailing or calling potential job applicants, the recruiters may use the rate at which job applicants respond to inquiries as a proxy for talent brand strength, where a higher rate of response is taken as a stronger talent brand. In the context of online systems, such as job hosting services, content publishing services, and social networking services, companies may have the opportunity to create a company profile or web page that others can choose to follow. For example, when a person follows a company, content that may be published on behalf of the company will be communicated to those who are following the company. Accordingly, the number of people following a company may be used as a proxy for talent brand strength. A wide variety of other engagement metrics might be used to measure talent brand strength. While these techniques may provide companies with some insight as to the strength of their talent brand, these techniques do not fit well together and do not provide companies with the ability to benchmark against other companies and/or the broader marketplace for talent.

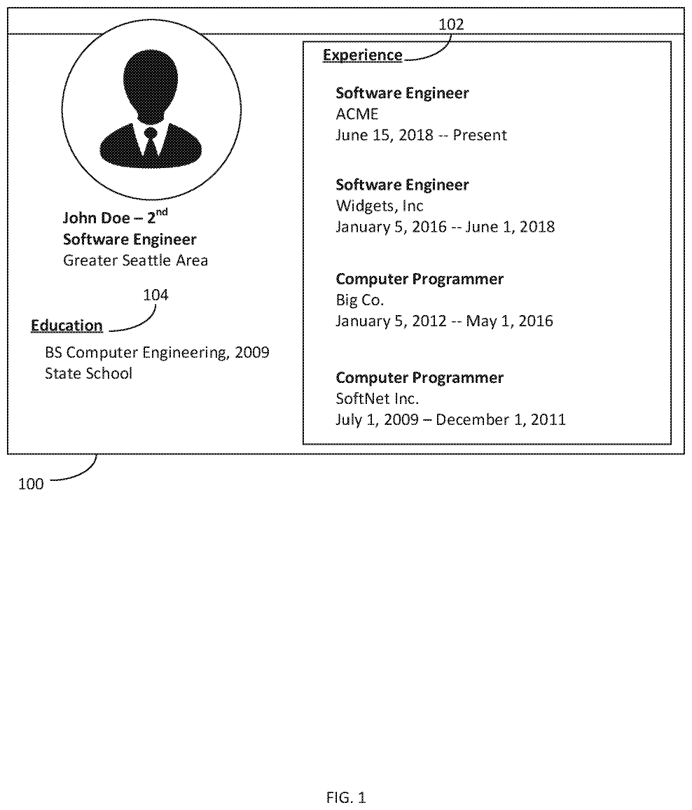

Another technique that has been used to measure talent brand strength is by analyzing employment history records to compare the number of employees that one company has gained from, and lost to, another company. As an example, consider the user interface showing an example of a member profile illustrated in FIG. 1. With some online systems, end-users provide information, such as their educational background 104 and employment history and experience 102, as part of a member profile or member profile page 100. This employment history information can be analyzed in the aggregate to establish the net number of employees that companies are gaining from, or losing to, other companies. In the example member profile of FIG. 1, the employment history information for the member, John Doe, shows four transitions, including a first transition from a student at State School to a position as a computer programmer with SoftNet Inc., and then three additional job transitions.

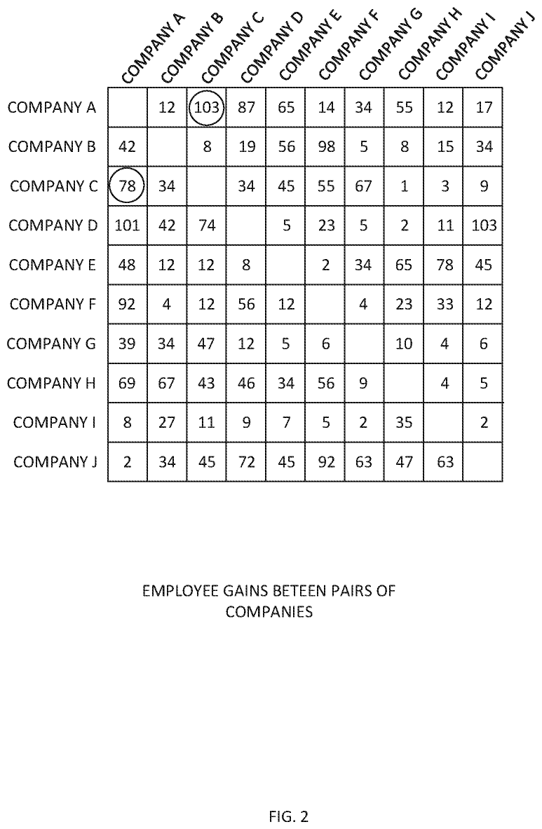

The table illustrated in FIG. 2 shows the results of analyzing member profile data to identify the transitions between pairs of companies that members indicated in their member profiles, over some period of time. As shown in the table of FIG. 2, the number at the intersection of each row and column indicates the number of employees gained by the company listed on the left side of the table, corresponding to the rows, from the company listed on the top of the table, corresponding to the columns. As an example, the circled number “78” in the third row and first column indicates that Company C hired seventy-eight employees away from Company A. Similarly, the circled number “103” in the first row and third column indicates that Company A hired one-hundred and three employees away from Company C. In this case, the net change is a plus twenty-five in favor of Company A.

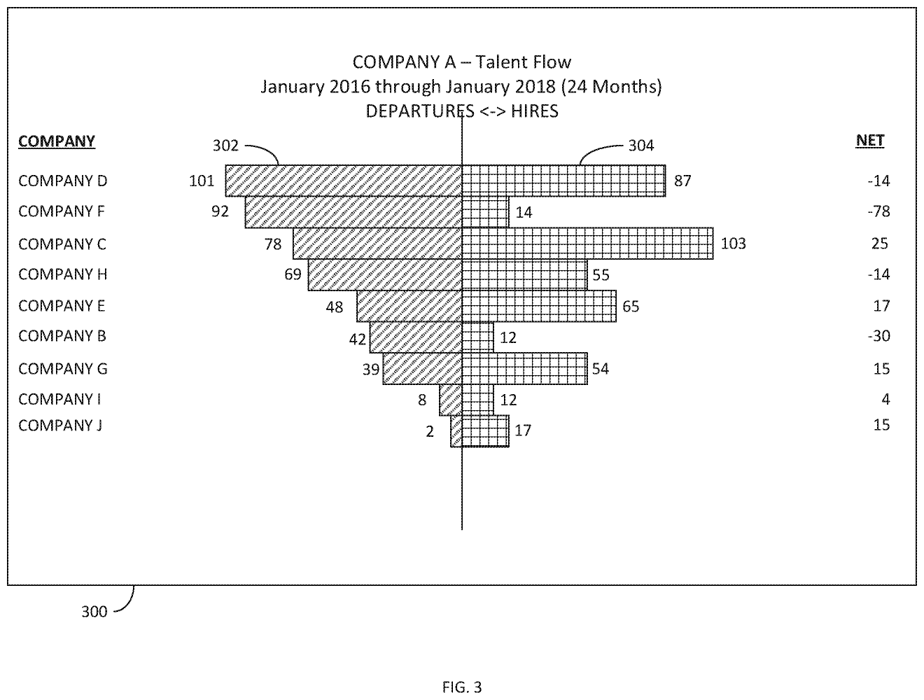

After analyzing the member profile data to identify the employee transitions, the information shown in the table of FIG. 2 can be presented in a chart referred to as a talent flow chart, such as that illustrated in FIG. 3. In the talent flow chart of FIG. 3, the net gain/loss of employees for Company A, relative to other companies, is shown. As an example, the bar with reference 302 represents the number of employees that departed Company A in favor of Company D. The bar with reference 304 represents the number of employees that Company A hired away from Company D. Accordingly, Company A realized a net loss of fourteen employees to Company D over the time period specified in the chart.

There are several advantages of this approach over those described above. First, employees and/or job candidates express their feelings about a brand when they choose to work for a company, or, choose to depart one company in favor of another. Accordingly, employee transition information is a very meaningful metric for talent brand strength. Furthermore, this approach to measuring talent brand strength provides a company with a meaningful benchmark against other companies. For example, the talent flow chart of FIG. 3 provides an easy to understand visual of the performance in hiring of Company A relative to several other companies.

However, there are still several problems with this approach to measuring talent brand strength. One problem is that all hires and departures are treated equally, which is of course not always the case. For example, making a hire for a senior position should not be equivalent to hiring for a junior or starting position. Additionally, the talent flow chart of FIG. 3 shows the net flow of employees between companies, which does not allow for a meaningful comparison between large companies, with lots of employees, and small companies, with just a few employees. For example, if an extremely large company with thousands of employees hires one-hundred new employees, this may not be a significant number of new hires when compared to a small company of fifty employees making one-hundred new hires.

Consistent with embodiments of the present invention, a talent brand rating score is derived for a company by analyzing information relating to employee hires and employee departures over some period of time, as indicated in the member profiles of members of an online system. At least with some embodiments, the algorithm used to derive the rating score for each company is based on the Elo Rating system, originally developed by Aprad Elo and used in rating the skill level of chess players. Whereas the original Elo Rating system adjusted the rating scores of chess players based on head-to-head wins and losses, consistent with embodiments of the present invention, each transition of an employee from one company to another is considered as a “win” for the hiring company, and a “loss” for the company from which the employee departed. Each company having a presence with the online system is assigned an initial baseline rating score at the beginning of some first time period, such that the baseline rating score for each company is the same. Then, for each employee transition from one company to another company, the rating scores of the respective companies are adjusted to reflect a “win” by the hiring company and a “loss” by the company from which the employee departed. The magnitude of the adjustment made to the rating scores is algorithmically determined based at least in part on the current rating scores of each company. With some embodiments, the magnitude of the adjustment is based in part on the difference of the companies' respective rating scores. In some instances, other factors may be taken into consideration in determining the magnitude of the adjustment (e.g., increase/decrease) to the talent brand rating score of the respective “winning” and “losing” companies. For example, with some embodiments, the magnitude of the adjustment that is made to a rating score after each win/loss (e.g., hire or departure) will be dependent upon the size of the company or companies involved, the seniority level of the employee making the transition, and/or the job title or job function of the employee making the transition.

By way of example, if Company A has a high talent brand rating score relative to Company B, there would naturally exist an expectation that Company A would “win” in any given competition for a particular employee. Accordingly, if an employee departs Company B for Company A, the talent brand rating score for Company A is increased, but only by some small amount as the magnitude of the increase reflects the fact that Company A had a high talent brand rating score, relative to Company B, and was therefore expected to “win”. Similarly, as Company B was not expected to win, as it had a lower talent brand rating score, the loss of an employee to Company A will have a relatively small impact (e.g., decrease) on the talent brand rating score of Company B. However, if Company B, with a lower talent brand rating score than Company A, hires an employee away from Company A, the adjustment to the talent brand rating score of Company B will be more significant, reflecting the difference in the respective talent brand rating scores between Company A and Company B. If Company A and Company B have similar (e.g., more or less equal) talent brand rating scores, meaning the expectations are such that each company has an equal or nearly equal opportunity to lure away an employee from the other, then the impact on the respective rating scores of the companies will be relatively small if and when an employee leaves one company for the other.

With some embodiments, the magnitude of the adjustment made to a rating score is subject to a weighting factor that may be tied to various characteristics of the companies, and/or characteristics of the employee making the transition. As an example, with some embodiments, when calculating the magnitude of an adjustment to be applied to a rating score as a result of an employee transition, a weighting factor may be used to increase or decrease the magnitude of the adjustment based on the size of the company or companies involved in the employee transition. If, for instance, the hiring company is an extremely large company with lots of employees, the weighting factor may be used to decrease the overall impact of the one additional hire on the rating score of the company. Because the company is an extremely large company, a single hire should not increase its rating score too significantly. Similarly, if a company is a very small company, with only a few employees, the weighting factor may boost or increase the magnitude of the adjustment to the company's talent brand rating score that results from an employee transition.

With some embodiments, the weighting factor may be dependent upon some characteristic(s) of the employee making the transition from one company to another. For instance, a weighting factor may be applied to increase the magnitude of an adjustment when the employee has a certain job title that is deemed to be important, or, when analysis of an employee's member profile indicates a certain level of seniority. Of course, a weighting factor may be used to decrease the magnitude of an adjustment to a rating score as well. For example, if an employee is transitioning from a school to a first job (e.g., a very junior level position), the rating score of the company may not be impacted too significantly. Other aspects of the present invention will be readily ascertainable from the description of the figures that follows.

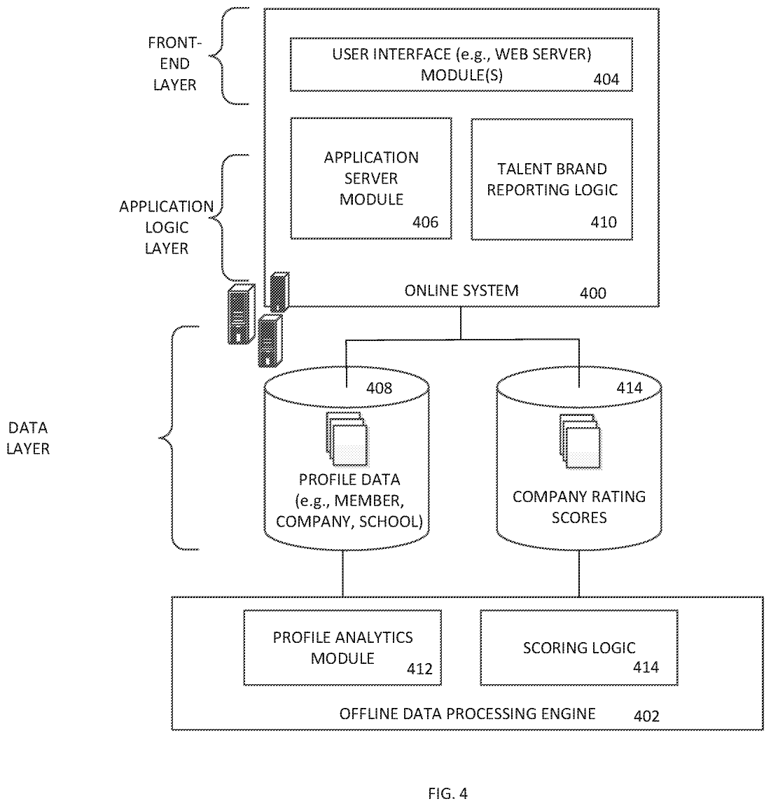

FIG. 4 is a block diagram illustrating functional components of an online system 400 having a data processing engine 402 for quantifying the desirability of employment with a company, relative to a set of peer companies, consistent with embodiments of the present invention. As shown in FIG. 4, the online system 400 is implemented with a three-layered architecture, generally consisting of a front-end layer, an application logic layer and a data layer. Of course, in other embodiments, different architectures may be used.

The front-end layer may comprise a user interface module (e.g., a web server) 404, which receives requests from various client computing devices and communicates appropriate responses to the requesting client devices. For example, the user interface module(s) 404 may receive requests in the form of Hypertext Transfer Protocol (HTTP) requests or other web-based API requests. The application logic layer may include one or more various application server modules 406, which, in conjunction with the user interface module(s) 404, generate various user interfaces (e.g., web pages) with data retrieved from various data sources in the data layer. Consistent with some embodiments, individual application server modules 404 are used to implement the functionality associated with various applications and/or services provided by the online system 400.

As shown in FIG. 4, the data layer may include several databases, such as a profile database 408 for storing profile data, including both member profile data and profile data for various organizations (e.g., companies, schools, etc.). Consistent with some embodiments, when a person initially registers to become a member of the online system, the person will be prompted to provide some personal information, such as his or her name, age (e.g., birthdate), gender, interests, contact information, home town, address, spouse's and/or family members' names, educational background (e.g., schools, majors, matriculation and/or graduation dates, etc.), employment history, skills, professional organizations, and so on. This information is stored, for example, in the profile database 408.

As shown in FIG. 4, the offline data processing engine comprises a framework for distributed storage and processing of extremely large data sets. In one example, the offline data processing engine may be implemented using Hadoop®, the Hadoop Distributed File System (HDFS™) and the MapReduce programming model. In alternative embodiments, Apache Spark may be used. Of course, any of a number of other alternative frameworks might also be used. The offline data processing engine 402 includes profile analytics logic 412 and scoring logic 414.

The profile analytics module 412 and the scoring logic 414 operate together to obtain and process member profile information, identify qualifying employee transitions, and then generate talent brand rating scores for some set of companies, based on the employee transitions. With some embodiments, the rating scores are generated based on employee transitions that have occurred over some historical time period (e.g., the last five years), and then subsequently updated on some periodic basis (e.g., bi-weekly, or monthly). Accordingly, during the updating process, only the qualifying employee transitions that have occurred in some most recent period of time (e.g., the last two weeks, or the last month) will be used to update each company's talent brand rating score.

The profile analytics module 412 obtains member profile information, for example, by querying the profile database 408. Upon obtaining the member profile information, the member profile information of each individual is processed in accordance with a set of rules to identify qualifying employee transitions. With some embodiments, a member's employment history will be stored in their profile as structured, or semi-structured text, such that the company name of the employer is stored in a separate field, and the start and end dates of employment are stored in separate fields. However, in some instances, additional processing of unstructured text may be necessary to identify the relevant information within each member's member profile. In any case, the profile analytics module will attempt to identify for each employment position indicated in a member's profile the company name, the employee's job title, job function, start date and end date. Then, using this information for all of the positions listed in the member's profile, the profile analytics module 410 will attempt to identify the qualifying employee transitions.

With some embodiments, only certain employee transitions will count as qualified, for purposes of impacting a company's talent brand rating score. For instance, with some embodiments, employment in a position with a company must satisfy some minimum length or duration in order for the transition out of the position to count as qualified. If, for example, an employment position is held for only a few months, the transition may not count as qualified for purposes of determining a company's talent brand rating score.

With some embodiments, the profile analytics module 412 may compare the company name for a particular employment position to a list of known and validated companies. It may be the case that only those companies having a valid company profile or company page hosted by the online system are included in the list of validated companies. If a company listed in a member's member profile is not included in the list of known and validated companies, then the transition to/from that company will be excluded from the qualifying employee transitions that impact a company's talent brand rating score.

In some instances, a member may list concurrent, active employment positions. At least with some embodiments, in such a scenario, the profile analytics module will identify the one position having the longest duration, and this employment position will be used for purposes of determining the qualifying employee transition. With some embodiments, if a member indicates that a position is a part-time position, or the member is employed in a temporary or contract position, the transition out of the position will not be included as a qualifying employee transition.

Once the profile analytics module 412 has analyzed and processed the member profile information to identify all of the qualifying employee transitions for the relevant time period under consideration, the scoring logic 414 will use the employee transition information to update the talent brand rating score for those companies impacted by the employee transitions—that is, those companies who gained or lost employees during the relevant time period. For each employee transition from one company to another, the company who hired the employee will have its talent brand rating score increased, while the company from which the employee departed will have its talent brand rating score decreased. With some embodiments, the scoring is consistent with a version of an Elo rating system. Accordingly, the magnitude of the increase/decrease resulting from the employee hire (win) and employee departure (loss) is determined in part based on the current rating scores of the two companies.

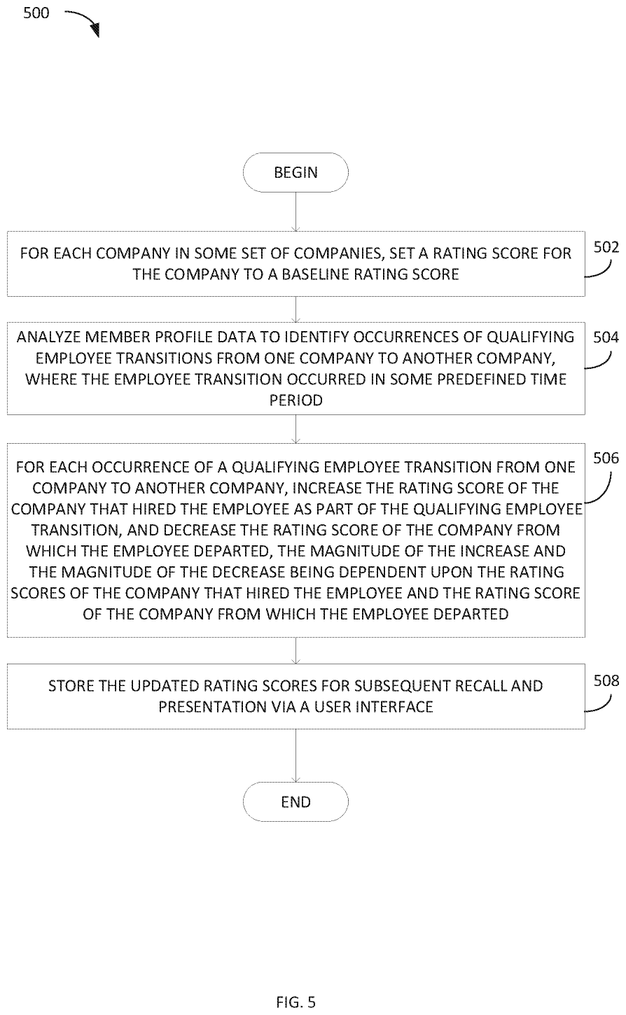

With some embodiments, a weighting factor may be applied to the adjustment, so as to increase or decrease the adjustment. The weighting factor may be dependent upon the size of the company (e.g., number of employees), such that larger companies will have less overall impact to their rating scores for any given employee transition, whereas smaller companies (e.g., fewer number of employees) will have a larger impact to their rating score per employee transition. With some embodiments, the weighting factor may be dependent upon the seniority level of the employee having made the transition. Accordingly, the weighting factor may be greater when the employee is more senior, such that the adjustment to a company's rating score for hiring a senior employee has a greater impact on the company's rating score than hiring a junior level position. The weighting factor may he dependent upon the job title or job function of the employee having made the transition. Accordingly, the impact to a company's rating score may be more significant, reflecting a higher weighting factor, when the employee being hired has a job title that is deemed important. The updated talent brand rating scores are then stored (e.g., in database 416) for subsequent recall and presentation by the talent brand reporting module 410. More details relating to the algorithm used by the scoring logic 414 are presented below in connection with the description of FIG. 5.

FIG. 5 is a flow diagram showing the method operations involved in a method for deriving the talent brand rating scores for a set of companies, consistent with some embodiments of the present invention. At method operation 502, each company in some set of companies has their talent brand rating score set to a baseline score. Accordingly, at time T=0, all companies have an equal rating score. The set of companies may be defined by those companies that are included in some list of validated companies, having standardized company names, and corresponding company profiles or pages hosted by the online system.

Next, at method operation 504, member profile data is analyzed to identify occurrences of qualifying employee transitions from one company to another company during the relevant time period. If the rating scores are being derived for the first time, the relevant time period may be some extended period of time in the past, such as, the last five years. However, once the rating scores have been generated for the first time, they will generally be updated on some periodic basis.

Once all of the qualifying employee transitions have been identified, at method operation 506, for each occurrence of a qualified employee transition in the relevant time period, the rating score of a company that hired an employee is increased, while the rating score of a company from which the employee departed is decreased. The magnitude of the increase and decrease are algorithmically determined in accordance with an Elo rating system or scheme, and are generally dependent upon the rating score of the hiring company, and the rating score of the company from which the employee departed. When all of the rating scores are updated to reflect the increases/decreases resulting from all employee transitions in the relevant time period, the rating scores are stored in a database for subsequent recall and presentation to users, via a user interface.

With some embodiments, the rating scores are updated in accordance with an Elo rating system. An example of how this may be implemented is provided below. Of course, this is but one example, and there are many variations of exact formulas for different Elo rating systems, consistent with embodiments of the present invention. In a conventional application of an Elo rating system, the rating system is used to rank players in head-to-head competitions. However, in the context of the present invention, each employee transition from one company to another is treated as a head-to-head competition, where the hiring company is allocated a “win” and the company from which the employee departed is allocated a “loss”. For purposes of this example, the first step is to express the transformed rating score of each company. Here, r(1) is an expression for the score for Company 1, while R(2) is the score for Company 2:

R(1)=10^{r(1)/400}

R(2)=10^{r(2)/400}

Next, the expected rating score for each company can be expressed as a function of each company's current score, as follows:

E(1)=R(1)/(R(1)+R(2))

E(2)=R(2)/(R(1)+R(2))

Accordingly, the expected score of Company 1 is its current score, divided by the sum of the current score for Company 1 and the current score for Company 2.

Depending upon the outcome of the employee transition—that is, which company is the hiring company and which company has lost an employee—the hiring company is allocated one point, and the company from which the employee departed is allocated no points. Assuming Company 1 is the hiring company, we have:

S(1)=1

S(2)=0

Finally, the updated rating score for each company is expressed as follows:

r′(1)=r(1)+(S(1)−E(1))

r′(2)=r(2)+(S(2)−E(2))

Accordingly, the adjustment to the rating score of Company 1 is the portion of the above equation expressed as, (S(1)−E(1)). The adjustment is dependent upon the initial rating scores of the two companies, as the expected rating score for each company is a function of the existing scores for the companies.

As previously set forth, with some embodiments, a weighting factor may be applied to the adjustment. In that scenario, the updated rating score for each company might be expressed as follows,

r′(1)=r(1)+K*(S(1)−E(1))

r′(2)=r(2)+K*(S(2)−E(2))

Here, the weighting factor, K, impacts the amount of the adjustment (increase or decrease) that is made to each company's rating score as a result of the employee transition.

In the examples provided thus far, all qualifying employee transitions have been considered in deriving a company's talent brand rating score. With some embodiments, specialized ratings scores may be derived to express the talent brand strength with respect to certain job functions or job titles. As an example, some companies may be perceived as a great place to work for certain job functions (e.g., sales, legal, engineering). Accordingly, with some embodiments, a talent brand rating score may be derived for a specific job function or job title. This can be done by including in the set of qualified employee transitions only those transitions made by employees who have a certain job function or job title listed in their member profiles.

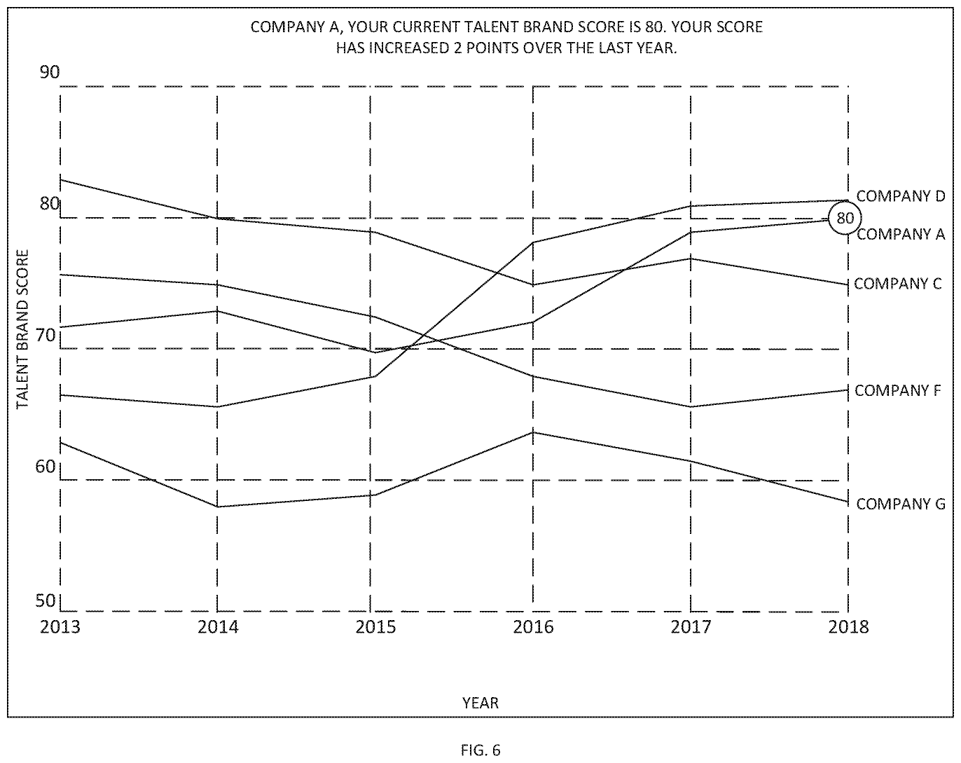

FIG. 6 is a line chart illustrating an example of a company's talent brand rating score plotted over time, and shown in relation to the talent brand rating scores of a set of peer companies, consistent with embodiments of the invention. With some embodiments, when an employee of a company and member of the online system makes a request to view his or her company's talent brand rating score, a line chart such as that shown in FIG. 6 is presented via a dashboard user interface. This line chart allows for an easy comparison of talent brand between peer companies. With some embodiments, the chart may be interactive in natures, such that the viewer can specify the particular peer companies with which to benchmark, and so forth.

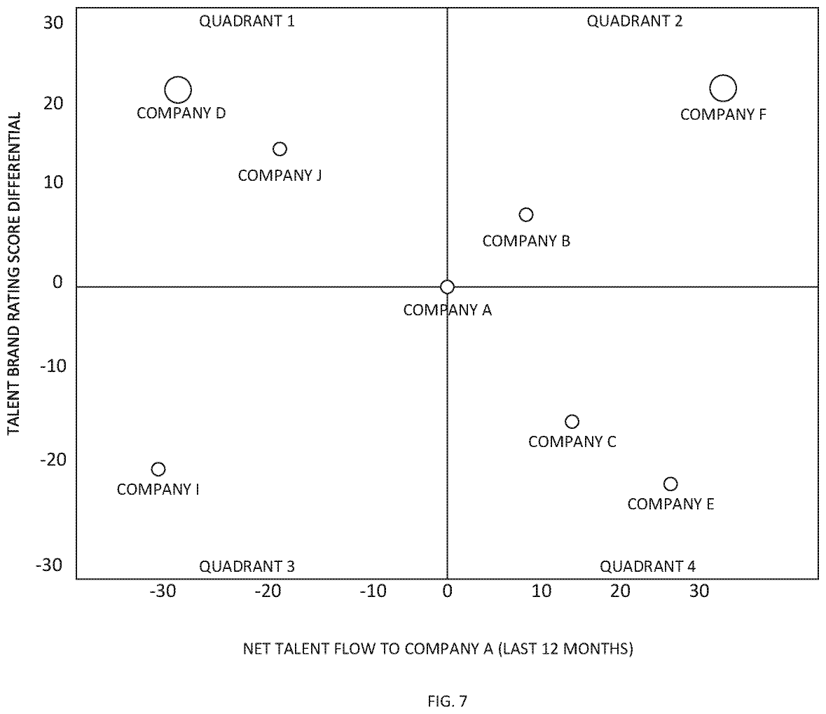

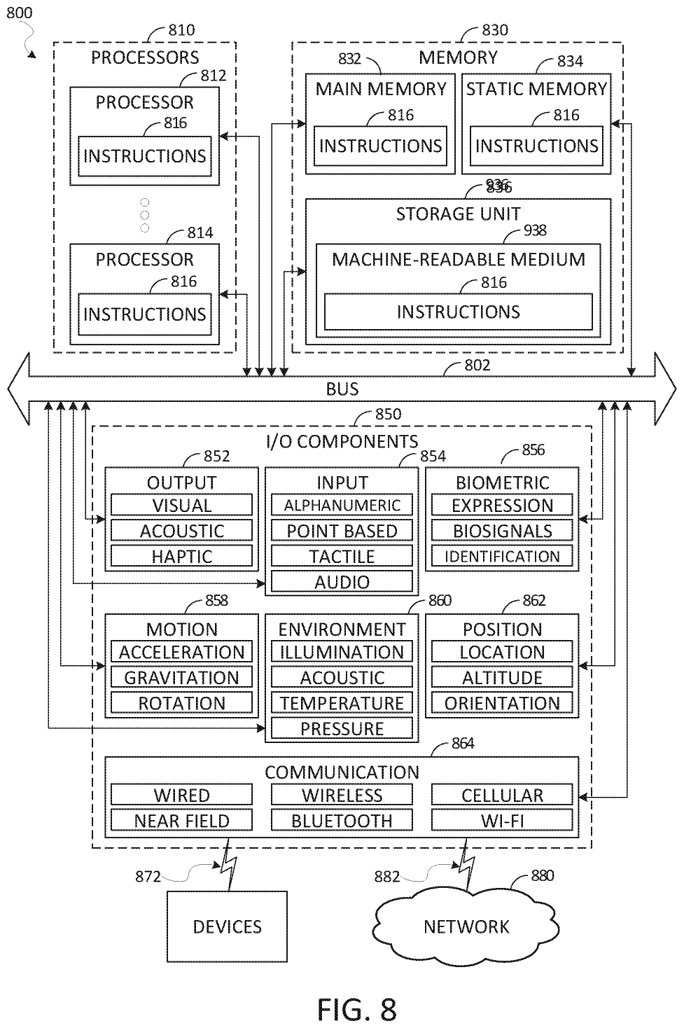

FIG. 7 is a user interface diagram showing an example of a chart that has companies mapped to quadrants based on their relative talent brand rating scores, consistent with embodiments of the invention. With some embodiments, the talent brand scores of some set of companies can be mapped to quadrants, as shown in FIG. 7. In this example, the companies are mapped to quadrants based on their net talent flow, with respect to Company A, and their talent brand rating score differential, again with respect to Company A. As such, those companies appearing in quadrant one are companies with higher talent brand scores than Company A, and companies to which Company A has lost employees over the relevant time period (e.g., last 12 months). The companies appearing in quadrant two have higher talent brand rating scores than Company A, but Company A has gained employees from those companies. In quadrant three, we see a single company with a lower talent brand score than Company A, but a company to which Company A has been losing employees. Finally, in quadrant four, there are two companies having lower talent brand scores than Company A, and from which Company A is winning talent (e.g., gaining employees). Armed with the knowledge set forth in the chart of FIG. 8, Company A can think more strategically about how to message its talent brand and how to go about recruiting and attracting talent.

FIG. 8 illustrates a diagrammatic representation of a machine 800 in the form of a computer system within which a set of instructions may be executed for causing the machine to perform any one or more of the methodologies discussed herein, according to an example embodiment. Specifically, FIG. 8 shows a diagrammatic representation of the machine 800 in the example form of a computer system, within which instructions 816 (e.g., software, a program, an application, an applet, an app, or other executable code) for causing the machine 800 to perform any one or more of the methodologies discussed herein may be executed. For example the instructions 816 may cause the machine 800 to execute method 500, or similar methods. Additionally, or alternatively, the instructions 816 may implement the systems described in connection with FIG. 4, and so forth. The instructions 816 transform the general, non-programmed machine 800 into a particular machine 800 programmed to carry out the described and illustrated functions in the manner described. In alternative embodiments, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a PC, a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 816, sequentially or otherwise, that specify actions to be taken by the machine 800. Further, while only a single machine 800 is illustrated, the term “machine” shall also be taken to include a collection of machines 800 that individually or jointly execute the instructions 816 to perform any one or more of the methodologies discussed herein.

The machine 800 may include processors 810, memory 830, and I/O components 850, which may be configured to communicate with each other such as via a bus 802. In an example embodiment, the processors 810 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 812 and a processor 814 that may execute the instructions 816. The term “processor” is intended to include multi-core processors that may comprise two or more independent processors (sometimes referred to as “cores”) that may execute instructions contemporaneously. Although FIG. 8 shows multiple processors 810, the machine 800 may include a single processor with a single core, a single processor with multiple cores (e.g., a multi-core processor), multiple processors with a single core, multiple processors with multiples cores, or any combination thereof.

The memory 830 may include a main memory 832, a static memory 834, and a storage unit 836, all accessible to the processors 810 such as via the bus 802. The main memory 830, the static memory 834, and storage unit 836 store the instructions 816 embodying any one or more of the methodologies or functions described herein. The instructions 816 may also reside, completely or partially, within the main memory 832, within the static memory 834, within the storage unit 836, within at least one of the processors 810 (e.g., within the processor's cache memory), or any suitable combination thereof, during execution thereof by the machine 800.

The I/O components 850 may include a wide variety of components to receive input, provide output, produce output, transmit information, exchange information, capture measurements, and so on. The specific I/O components 850 that are included in a particular machine will depend on the type of machine. For example, portable machines such as mobile phones will likely include a touch input device or other such input mechanisms, while a headless server machine will likely not include such a touch input device. It will be appreciated that the I/O components 850 may include many other components that are not shown in FIG. 8. The I/O components 850 are grouped according to functionality merely for simplifying the following discussion and the grouping is in no way limiting. In various example embodiments, the I/O components 850 may include output components 852 and input components 854. The output components 852 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 854 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 850 may include biometric components 856, motion components 858, environmental components 860, or position components 862, among a wide array of other components. For example, the biometric components 856 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 858 may include acceleration sensor components (e.g., accelerometer), gravitation sensor components, rotation sensor components (e.g., gyroscope), and so forth. The environmental components 860 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 862 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 850 may include communication components 864 operable to couple the machine 800 to a network 880 or devices 870 via a coupling 882 and a coupling 872, respectively. For example, the communication components 864 may include a network interface component or another suitable device to interface with the network 880. In further examples, the communication components 864 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 870 may be another machine or any of a wide variety of peripheral devices (e.g., a peripheral device coupled via a USB).

Moreover, the communication components 864 may detect identifiers or include components operable to detect identifiers. For example, the communication components 864 may include Radio Frequency Identification (RHD) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 864, such as location via Internet Protocol (IP) geolocation, location via Wi-Fi® signal triangulation, location via detecting an NFC beacon signal that may indicate a particular location, and so forth.

### Executable Instructions and Machine Storage Medium

The various memories (i.e., 830, 832, 834, and/or memory of the processor(s) 810) and/or storage unit 836 may store one or more sets of instructions and data structures (es., software) embodying or utilized by any one or more of the methodologies or functions described herein. These instructions (e.g., the instructions 816), when executed by processor(s) 810, cause various operations to implement the disclosed embodiments.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not he limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Transmission Medium

In various example embodiments, one or more portions of the network 880 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 880 or a portion of the network 880 may include a wireless or cellular network, and the coupling 882 may be a Code Division Multiple Access (CDMA) connection, a Global System for Mobile communications (GSM) connection, or another type of cellular or wireless coupling. In this example, the coupling 882 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide interoperability for Microwave Access (WiMAX), Long Term Evolution (LTE) standard, others defined by various standard-setting organizations, other long range protocols, or other data transfer technology.

The instructions 816 may be transmitted or received over the network 980 using a transmission medium via a network interface device (e.g., a network interface component included in the communication components 864) and utilizing any one of a number of well-known transfer protocols (e.g., HTTP). Similarly, the instructions 816 may be transmitted or received using a transmission medium via the coupling 872 (e.g., a peer-to-peer coupling) to other devices. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 816 for execution by the machine 800, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

### Computer-Readable Medium

The terms “machine-readable medium,” “computer-readable medium” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A computer-implemented method for rating the desirability of employment with a company relative to other companies, the method comprising:
for each company in some set of companies, setting a rating score for the company to a baseline rating score;
analyzing employment history information indicated in member profiles of an online system to identify, for a specific time period, each occurrence of a qualifying employee transition from one company in the set of companies to another company in the set of companies;
for each occurrence of a qualifying employee transition occurring during the specific time period, increasing the rating score of a company at which the employee was hired as part of the qualifying employee transition, and decreasing the rating score of a company from which the employee departed as part of the qualifying employee transition, wherein the magnitude of the increase to the rating score of the company at which the employee was hired and the magnitude of the decrease of the rating score of the company from which the employee departed are dependent upon the difference in the rating scores of the company at which the employee was hired and the company from which the employee departed; and
responsive to a request to view a rating score of a particular company, presenting the rating score of the particular company in a user interface.

2. The computer-implemented method of claim 1, further comprising:
excluding as a qualifying employee transition any employee transition that occurred after an employee was employed with a company for a duration of time less than some threshold duration of time, according to the member profile of the employee.

3. The computer-implemented method of claim 1, further comprising:
excluding as a qualifying employee transition any employee transition by an employee, who, according to the member profile of the employee, was employed with contractor status or employed on a less than full-time basis.

4. The computer-implemented method of claim 1, further comprising:
excluding as a qualifying employee transition any employee transition by an employee, who, according to the member profile of the employee, transitioned to, or transitioned from, a company that is not in the set of companies.

5. The computer-implemented method of claim 1, further comprising:
applying a weighting factor to the magnitude of the increase to the rating score of the company at which the employee was hired, the weighting factor dependent upon the size of the company at which the employee was hired.

6. The computer-implemented method of claim 1, further comprising:
applying a weighting factor to the magnitude of the increase to the rating score of the company at which the employee was hired, the weighting factor dependent upon a level of seniority of the employee that was hired, as deter mined from the member profile of the employee.

7. The computer-implemented method of claim 1, further comprising:
applying a weighting factor to the magnitude of the increase to the rating score of the company at which the employee was hired, the weighting factor dependent upon a job title or job function of the employee that was hired, as determined from the member profile of the employee.

8. The computer-implemented method of claim 1, further comprising:
on some periodic basis, for some additional period of time, updating the rating score of each company in the set of companies by:
analyzing employment history information indicated in member profiles of an online system to identify, for the additional time period, each occurrence of a qualifying employee transition from one company in the set of companies to another company in the set of companies;
for each occurrence of a qualifying employee transition occurring during the additional period of time, increasing the rating score of a company at which the employee was hired as part of the qualifying employee transition, and decreasing the rating score of a company from which the employee departed as part of the qualifying employee transition, wherein the magnitude of the increase to the rating score of the company at which the employee was hired and the magnitude of the decrease of the rating score of the company from which the employee departed are dependent upon the difference in the rating scores of the company at which the employee was hired and the company from which the employee departed.

9. The computer-implemented method of claim 8, further comprising:
receiving a request to view a rating score of a specific company; and
responsive to the request, presenting via a user interface a line chart indicating the rating score of the specific company and the rating scores of some subset of other companies, at various moments in time.

10. A system comprising:
a machine-readable medium storing instructions, which, when executed by a computer processor, cause the system to:
for each company in some set of companies, set a rating score for the company to a baseline rating score;
analyze employment history information indicated in member profiles of an online system to identify, for a specific time period, each occurrence of a qualifying employee transition from one company in the set of companies to another company in the set of companies;
for each occurrence of a qualifying employee transition occurring during the specific time period, increase the rating score of a company at which the employee was hired as part of the qualifying employee transition, and decrease the rating score of a company from which the employee departed as part of the qualifying employee transition, wherein the magnitude of the increase to the rating score of the company at which the employee was hired and the magnitude of the decrease of the rating score of the company from which the employee departed are dependent upon the difference in the rating scores of the company at which the employee was hired and the company from which the employee departed; and
responsive to a request to view a rating score of a particular company, presenting the rating score of the particular company in a user interface.

11. The system of claim 10, further comprising:
additional instructions stored on a machine-readable medium, which, when executed by a processor, cause the system to:
exclude as a qualifying employee transition any employee transition that occurred after an employee was employed with a company for a duration of time less than some threshold duration of time, according to the member profile of the employee.

12. The system of claim 10, further comprising:
additional instructions stored on a machine-readable medium, which, when executed by a processor, cause the system to:
exclude as a qualifying employee transition any employee transition by an employee, who, according to the member profile of the employee, was employed with contractor status or employed on a less than full-time basis.

13. The system of claim 10, further comprising:
additional instructions stored on a machine-readable medium, which, when executed by a processor, cause the system to:
exclude as a qualifying employee transition any employee transition by an employee, who, according to the member profile of the employee, transitioned to, or transitioned from, a company that is not in the set of companies.

14. The system of claim 10, further comprising:
additional instructions stored on a machine-readable medium, which, when executed by a processor, cause the system to:
apply a weighting factor to the magnitude of the increase to the rating score of the company at which the employee was hired, the weighting factor dependent upon the size of the company at which the employee was hired.

15. The system of claim 10, further comprising:
additional instructions stored on a machine-readable medium, which, when executed by a processor, cause the system to:
apply a weighting factor to the magnitude of the increase to the rating score of the company at which the employee was hired, the weighting factor dependent upon a level of seniority of the employee that was hired, as determined from the member profile of the employee.

16. The system of claim 10, further comprising:
additional instructions stored on a machine-readable medium, which, when executed by a processor, cause the system to:
apply a weighting factor to the magnitude of the increase to the rating score of the company at which the employee was hired, the weighting factor dependent upon a job title or job function of the employee that was hired, as determined from the member profile of the employee.

17. The system of claim 10, further comprising:
additional instructions stored on a machine-readable medium, which, when executed by a processor, cause the system to:
analyze employment history information indicated in member profiles of an online system to identify, for the additional time period, each occurrence of a qualifying employee transition from one company in the set of companies to another company in the set of companies;
for each occurrence of a qualifying employee transition occurring during the additional period of time, increasing the rating score of a company at which the employee was hired as part of the qualifying employee transition, and decreasing the rating score of a company from which the employee departed as part of the qualifying employee transition, wherein the magnitude of the increase to the rating score of the company at which the employee was hired and the magnitude of the decrease of the rating score of the company from which the employee departed are dependent upon the difference in the rating scores of the company at which the employee was hired and the company from which the employee departed.

18. The system of claim 10, further comprising:
additional instructions stored on a machine-readable medium, which, when executed by a processor, cause the system to:
receive a request to view a rating score of a specific company; and
responsive to the request, present via a user interface a line chart indicating the rating score of the specific company and the rating scores of some subset of other companies, at various moments in time.

19. A computer-implemented method for rating the desirability of employment with a company relative to other companies, the method comprising:
for each company in some set of companies, setting a rating score for the company to a baseline rating score;
analyzing employment history information indicated in member profiles of an online system to identify, for a specific time period, each occurrence of a qualifying employee transition from one company in the set of companies to another company in the set of companies;
for each occurrence of a qualifying employee transition occurring during the specific time period, increasing the rating score of a company at which the employee was hired as part of the qualifying employee transition, and decreasing the rating score of a company from which the employee departed as part of the qualifying employee transition, wherein the magnitude of the increase to the rating score of the company at which the employee was hired and the magnitude of the decrease of the rating score of the company from which the employee departed are determined using an Elo rating system and are dependent upon the difference in the rating scores of the company at which the employee was hired and the company from which the employee departed; and
responsive to a request to view a rating score of a particular company, presenting a line chart with at least one line in the line chart representing the rating score of the particular company over time.

20. The computer-implemented method of claim 19, further comprising:
presenting the line chart with one or more lines representing the rating scores of other companies over time.
